(19) United States
(12) Patent Application Publication
(10) Pub. No.: US 2018/0240158 A1
(43) Pub. Date: Aug. 23, 2018

(54) COMPUTER IMPLEMENTED SYSTEM AND METHOD FOR CUSTOMER PROFILING USING MICRO-CONVERSIONS VIA MACHINE LEARNING

(71) Applicant: Kasatria Analytics Sdn Bhd, Wilayah Persekutuan Kuala Lumpur (MY)

(72) Inventor: Chan Kin Peng, Kuala Lumpur (MY)

(73) Assignee: Kasatria Analytics Sdn Bhd, Wilayah Persekutuan Kuala Lumpur (MY)

(21) Appl. No.: 15/599,428

(22) Filed: May 18, 2017

(30) Foreign Application Priority Data
Feb. 17, 2017 (MY) PI 2017700535

(51) Int. Cl. G06Q 30/02; G06N 99/00; G06F 17/30

(52) U.S. Cl. CPC G06Q 30/0271; G06F 17/30864; G06N 99/005; G06Q 30/0253

(57) ABSTRACT

Providing targeted contents to customers in an online marketing environment by performing customer profiling by identifying the interests of a plurality of customer using their past behavior. A method includes collecting a plurality of information related to a number of interactions of the customers with the contents presented through a user interface of an electronic device, receiving and processing the plurality of information using an Extract, Transform and Load module, categorizing the information using a machine learning module, storing the information using a data warehousing module, processing the information using a Data-as-a-Service module to provide to personalized recommendations to the customers in real-time. The Data-as-a-Service module profiles the customers, recommends a plurality of services to the customers through a plurality of e-commerce platforms using a content recommendation module, and recommends a plurality of products to the customers through a plurality of e-commerce platforms using a product recommendation module.

### FIELD OF INVENTION

The present invention relates generally to a system and method for providing targeted contents to a plurality of customers in an online marketing environment, and more specifically, to a system and method for performing customer profiling by identifying the interests of a plurality of customer using their past behaviour for providing personalized contents to the customers in an online marketing environment BACKGROUND

A variety of systems exist for selecting content, such as advertisements, to present on web pages based on the content of such web pages. These systems often fail to select content that is relevant to, or suitable for display on, the particular page at issue. For example, an ad for a particular product or company may be selected to display on a web page containing an article that is critical of that product or company. As another example, an ad for a particular product may be displayed on a page containing an article about a completely unrelated topic merely because the product is briefly mentioned in the article. Existing systems also frequently display the selected ad in a manner that is distracting to users. These and other issues contribute to a low industry-wide click through rate of less than 1%.

Traditionally, most of the data mining work using retail transaction data has focused on approaches that use clustering or segmentation strategies. Each customer is “profiled” based on other “similar” customers and placed in one or more clusters. This is usually done to overcome the data sparseness problem and results in systems that are able to overcome the variance in the shopping behaviors of individual customers, while losing precision on any one customer. A major reason that individually targeted applications have not been more prominent in retail data mining research is that in the past there has been no effective individualized channel to the customer for brick & mortar retailers. Direct mail is coarse-grained and not very effective as it requires the attention of customers at times when they are not shopping and may not be actively thinking about what they need. Coupon based initiatives given at checkout-time are seen as irrelevant as they can only be delivered after the point of sale. Studies have shown that grocers lose out on potentially 11% of sales due to forgotten items, which highlights the need to find effective individual channels to customers at the point of sale prior to check out.

Many systems collect historical data about every transaction that every customer performs with that organization. Such historical transactional data is useful in various one-to-one marketing applications, such as, e.g., shopping assistant application and dynamic Web site content presentation. A number of problems have been encountered in these marketing applications. One such problem relates to the creation of highly pertinent and comprehensible individual user profiles that are derived from the historical transactional data. In addition, it is also important to have the ability to utilize these user profiles when the marketing application obtains a current status of the user. If the user profiles are generated in a highly relevant and comprehensible manner with respect to a specific user, the applications would be able to understand that user's needs better and more efficiently serve that user.

There exists certain prior art, which disclose methods for providing targeted contents to customers. One such prior art is U.S. Pat. No. 7,945,473 B2 titled “System for individualized customer interaction”, which discloses a method and system for using individualized customer models when operating a retail establishment is provided. The individualized customer models may be generated using statistical analysis of transaction data for the customer, thereby generating sub-models and attributes tailored to customer. The individualized customer models may be used in any aspect of a retail establishment's operations, ranging from supply chain management issues, inventory control, promotion planning such as selecting parameters for a promotion or simulating results of a promotion, to customer interaction such as providing a shopping list or providing individualized promotions.

Another prior art U.S. Pat. No. 8,762,302 B1 titled “System and method for revealing correlations between data streams” discloses techniques that can provide users with a tool having an integrated, user-friendly interface and having automated mechanisms which can reveal correlations between data streams to the users in a clear and easily understandable way, thereby enabling the users to easily digest the vast amount of information contained in activities within one or more network, to understand the correlations among the activities, to stay informed and responsive to current or new trends, and even to predict future trends. Among other benefits, the disclosed techniques are especially useful in the context of discovering impacts of social networking activities on other types of commercial activities.

Another prior art U.S. Pat. No. 7,680,685 B2 titled “System and method for modeling affinity and cannibalization in customer buying decisions” discloses a computer implemented method of modeling customer response comprising providing a linear relationship between functions related to first and second products. The computer system models customer response using observable data. The observable data includes transaction, product, price, and promotion. The computer system receives data observable from customer responses. A set of factors including customer traffic within a store, selecting a product, and quantity of selected product is defined as expected values, each in terms of a set of parameters related to customer buying decision. A likelihood function is defined for each of the set of factors. The parameters are solved using the observable data and associated likelihood function. The customer response model is time series of unit sales defined by a product combination of the expected value of customer traffic and the expected value of selecting a product and the expected value of quantity of selected product. A linear relationship is given between different products which includes a constant of proportionality that determines affinity and cannibalization relationships between the products.

Yet another prior art U.S. Pat. No. 6,236,978 B1 titled “System and method for dynamic profiling of users in one-to-one applications” discloses a system and method for generating a user profile for a user based on a static profile and a dynamic profile of the user. The static profile includes factual user information. The dynamic profile includes dynamic rules which correspond to transactional information of the user. The method and system compresses the dynamic rules into aggregated rules so that the user can view a comparatively small number of the aggregated rules and select the desired rules from the aggregated rules based on user-desired criteria. The dynamic rules associated with the particular user are matched to the selected desired aggregated rules to generate the dynamic profile. The static and dynamic profile are then combined to form the user profile. The system and method can be used in conjunction with a Personal Shopping Assistant system and a Personal Intelligent Digital Assistant system.

Hence there exists a need for a system and method for customer profiling that employs machine learning to understand the customer's intention based on their past behavior. The needed method would further predict demand with a certain degree of statistical certainty. The needed method would utilize the customer profiles to provide more effective and targeted products and services to the customers through own web platforms and other third party e-commerce platforms.

### SUMMARY

The present disclosure relates to a system and method for providing targeted contents to customers in an online marketing environment.

The computer implemented system for performing customer profiling of a plurality of customers for providing personalized contents to the customers in an online marketing environment includes an electronic device capable of presenting a plurality of contents to a plurality of users through a user interface, where the electronic device comprises at least one processor to process a plurality of instructions to collect a plurality of information related to a plurality of interactions of the user on the contents presented through the user interface and at least one communication module to transfer the plurality of information related to the plurality of interactions of the users over a communication channel. The system further includes a central server in communication with the electronic device to receive the plurality of information related to the interactions of the users on the contents presented to the users through the user interface of the electronic device, where the central server receives the plurality of information related to the interactions of the users through the communication channel. The server further runs an application that analyzes the information related to the interactions of the users, where the application includes an Extract, Transform and Load (ETL) module to collect and process the information related to the interactions of the users from the electronic device, a machine learning module for processing and categorizing the information and classifying the customers and performing profiling of the customers based on the information, a data warehousing module to store and the information related to the interactions of each user and a data as a service (DaaS) module in communication with the machine learning module to provide product and content recommendations to the users. The application captures a plurality of digital micro-conversions to track customer behavior and analyzes historical behavior of the customers to perform customer profiling and classification of the customers to predict demand and provide targeted products and services to the customers through a plurality of e-commerce platforms.

The method includes the steps of collecting a plurality of information related to a number of interactions of the customers with the contents presented through a user interface of an electronic device, receiving and processing the plurality of information using an Extract, Transform and Load (ETL) module, categorizing the information using a machine learning module, storing the information using a data warehousing module, processing the information using a Data-as-a-Service (DaaS) module to provide to personalized recommendations to the customers in real-time, wherein the Data-as-a-Service (DaaS) module performs the steps of profiling the customers using a customer profiling module based on the plurality of information related to the interactions and interests of the customers and a plurality of historical behavior of the customers retrieved from the data warehousing module, recommending a plurality of services to the customers through a plurality of e-commerce platforms using a content recommendation module and recommending a plurality of products to the customers through a plurality of e-commerce platforms using a product recommendation module. The machine learning module captures a number of digital micro-conversions to track customer behavior and analyzes historical behavior of the customers to perform customer profiling and classification of the customers to predict customer demand and provide targeted products and services to the customers through online platforms.

Other objects and advantages of the embodiments herein will become readily apparent from the following detailed description taken in conjunction with the accompanying drawings.

### BRIEF DESCRIPTIONS OF THE DRAWINGS

FIG. 1 illustrates a block diagram showing a computer implemented system for performing customer profiling of a number of customers for providing personalized contents to the customers in an online marketing environment, according to a preferred embodiment of the present invention;

FIG. 2 illustrates the block diagram of the electronic device for presenting the contents to the users and to collect the interactions and interests of the customers with the contents, according to an embodiment of the present invention;

FIG. 3A illustrates a user interface showing the contents presented through a website for preparing scroll graph using a data analytics program, according to an embodiment of the present invention;

FIG. 3B illustrates a user interface showing the contents presented through the website for preparing click graph representing user interactions using a data analytics program, according to an embodiment of the present invention;

FIG. 3C illustrates an example of customer profiles generated or built based on enriched data models, according to an embodiment of the present invention;

FIG. 4 is a block diagram showing the different modules of the server in communication with the electronic devices, according to a preferred embodiment of the present invention; and

FIG. 5 is a block diagram showing the different processing blocks associated with the present system and method for providing targeted contents to the customers in an online marketing environment, according to an embodiment of the present invention.

### DETAILED DESCRIPTION

In the following detailed description, a reference is made to the accompanying drawings that form a part hereof, and in which the specific embodiments that may be practiced is shown by way of illustration. The embodiment are described in sufficient detail to enable those skilled in the art to practice the embodiments and it is to be understood that the logical and other changes may be made without departing from the scope of the embodiments. The following detailed description is therefore not to be taken in a limiting sense.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure relates to systems and methods for providing targeted contents to a number of users in an online environment. In one embodiment, the method for providing targeted contents to a number of users in an online environment includes the step of performing customer profiling of the users or the customers based on information collected from online data analytics platforms and the past behavior of the users on the contents presented to the user through a user interface of an online marketing environment, such as, but not limited to a website, web application etc. The method includes a machine learning program for processing and categorizing the information related to the activities and interests of the user obtained from the interactions of the user with the contents presented to the user through the user interface of an electronic device such as but not limited to a computer or smartphone operated by the user. The present system collects the user behavior and stores each user behavior in a data warehouse for further processing and classification by the machine-learning module. In short, the present system and method collects the real-time and historical user behavior including user interests and brand or product or service affinity and perform customer profiling and classification of the customers to predict customer demand and provide targeted products and services to the customers through a variety of e-commerce platforms.

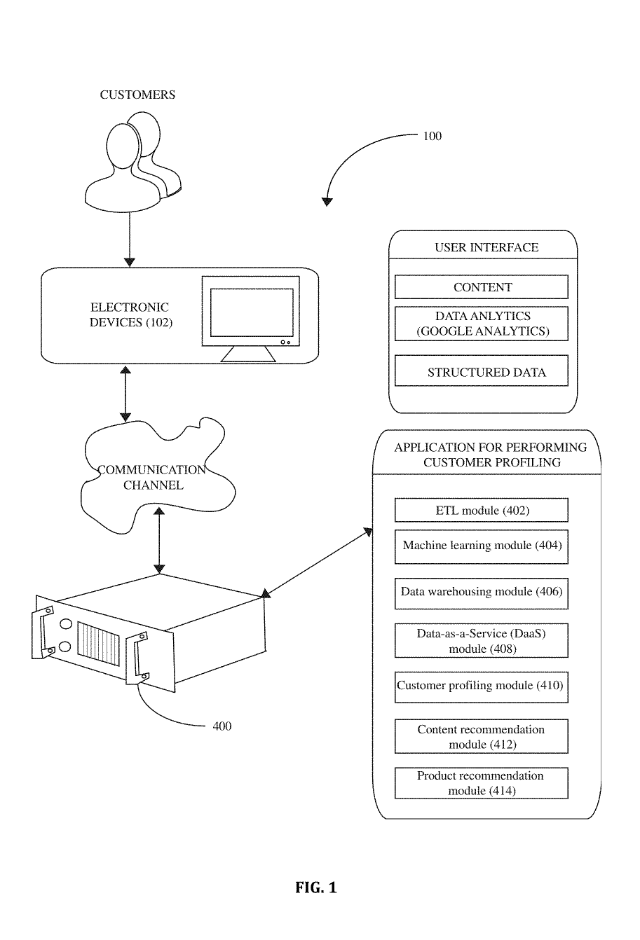

FIG. 1 illustrates a block diagram showing a computer implemented system (100) for performing customer profiling of a number of customers for providing personalized contents to the customers in an online marketing environment, according to a preferred embodiment of the present invention. The present system (100) includes one or more electronic devices (102), such as, but not limited to, a computer, laptop, smartphone, tablet, wearable devices, and other smart electronic devices connected to Internet and at least one central server (400) in communication with the electronic devices (102) over a communication channel, such as, but not limited to, LAN, WAN, WiFi, Internet or others. The users can use the electronic device (102) to launch a desired content from Internet and the content is displayed on the user interface of the device (102). Now the users can interact with the contents presented to them through clicking, scrolling, sharing the content etc. and the activities or interactions of the user with the contents are collected by a number of data analytics modules, such as but not limited to, Google analytics, Google 360, etc., associated with the content. The collected information is transferred to the server (400) over the communication channel. The server (400) includes an Extract, Transform and Load (ETL) module (402) to receive, store and process the received information, a machine learning module (404) for processing and categorizing the information and classifying the customers and performing profiling of the customers based on the information, a data warehousing module (406) to store and the information related to the interactions of each user and a data as a service (DaaS) module (408) in communication with the machine learning module (404) to provide product and content recommendations to the users. The present system and processing method captures a plurality of digital micro-conversions to track customer behavior and analyzes historical behavior of the customers to perform customer profiling and classification of the customers to predict demand and provide targeted products and services to the customers through the e-commerce platforms and other online content sites.

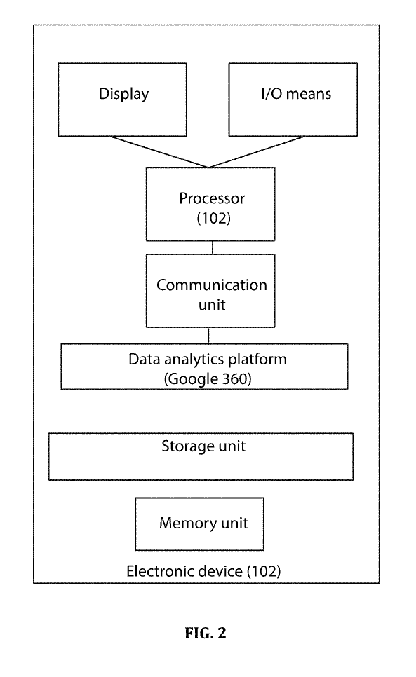

FIG. 2 illustrates the block diagram of the electronic device (102) for presenting the contents to the users and to collect the interactions and interests of the customers with the contents, according to an embodiment of the present invention. The electronic device (102) can be selected from a group consisting of, but not limited to, laptop, computers, smartphones, tablets, wearable devices, and other electronic devices capable of presenting a variety of contents to the users through a user interface such as the display screen of the device (102). The electronic device (102) includes a processor (202), which is capable of processing a variety of information and executable instructions of multiple programs to present a variety of contents on the user interface of the device (102). The users can interact with the contents presented through the user interface of the electronic device (102) using interactive means such as keyboard, mouse, other electronic pointing and selecting devices. In some cases, the contents are presented through the user interface of a touchscreen and the users can interact with the contents using touch, gestures and any other smart interactive methods. The interactions of the user with the contents presented through the user interface are tracked and analyzed using data analytics modules, such as, but not limited to, Google analytics.

In some instances the contents presented to the users includes websites, software applications, web applications, advertisements, e-commerce platforms etc., and the users are allowed to register into the websites or the applications and the personal, location area of interest, contact information etc., are collected by the data analytics software associated with the present system (100). The present system (100) collects data about users and the registered customers accessing particular information through the user interface of the electronic device (102) in real-time and stores the information for further processing and analysis. The data analytics programs associated with the present system (100) tracks the activities of each user or registered customers and transfers the activity information associated with each user or each customer to the server for storage and further processing, classification and categorization. The data analytics programs such as Google analytics and Google 360 tracks and collects information about the user behavior including real-time and past behavior of the users or the customers. In some instances, the collected information includes, but not limited to, traffic source, location, online behavior, areas of interest, contact details, personal details, customer record, purchase history, etc. The collected data including the real-time and historical information about the interactions or activities or affinities of the users complements the customer profile and is utilized for building the customer profile of each customer or each user. The data analytics program, such as, Google Analytics 360, associated with the present system (100) and method take into account the data that is based on purchases and transactions of the user in addition to the behavior and micro-conversions across all three phases of customer engagement, such as, anonymous customer, customer with contact information and other registered customers. The micro conversions associated with each user determined using the data analytics program, such as, Google Analytics 360, track the track behavior and understand interests of each user.

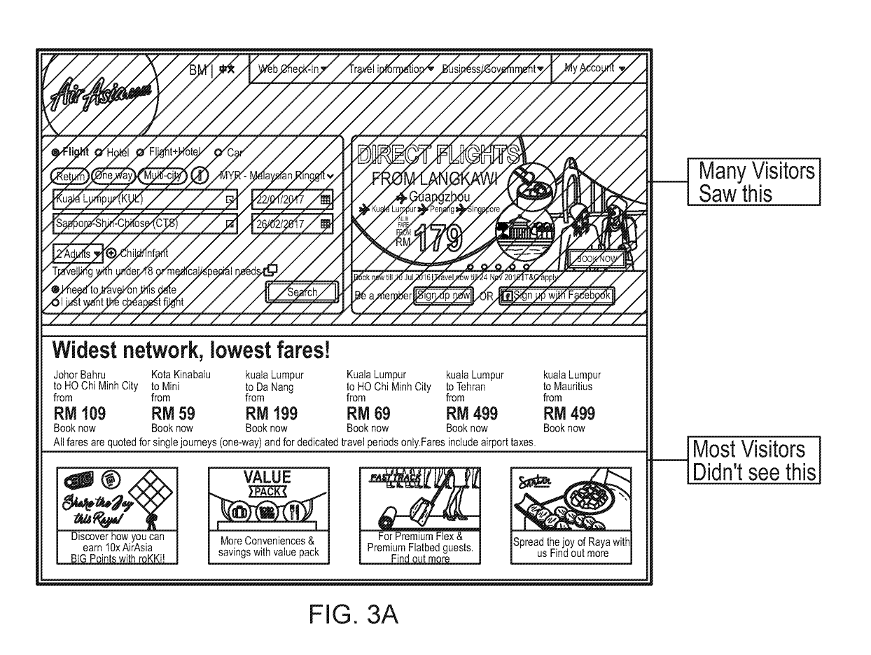

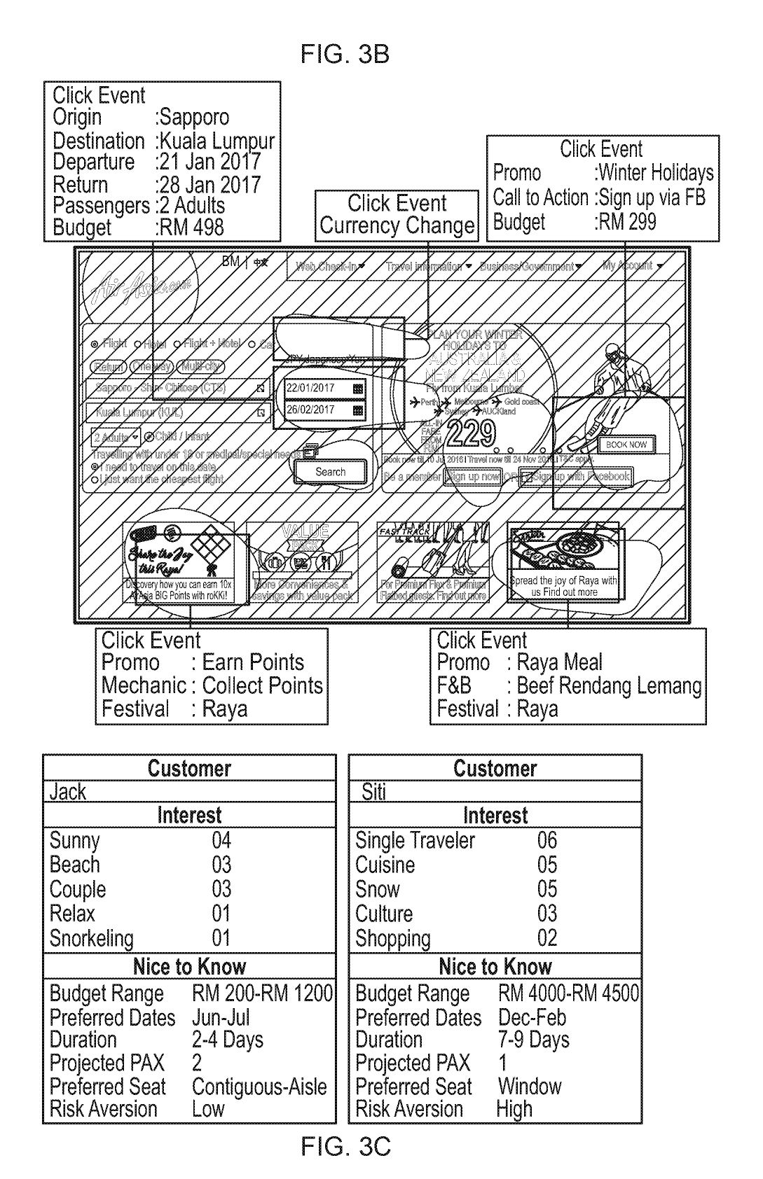

For example, the data analytics program, such as, Google Analytics 360, collects the scroll maps of each websites to identify what the customers can see and the responses of each customer to the contents presented through the website as shown in FIG. 3A. From the scroll maps, the data analytics program can understand the interests of each customers such as the viewed contents of the website by the customers and skipped contents of the website. Further the click maps associated with the data analytics program can assess what content the customer was interacted with as shown in FIG. 3B. The click graph represents the objected interacted on by user. According to an embodiment, the data analytics program may capture all clicks made by a user. This process generates a clickstream containing X & Y coordinates that determine all elements clicked on by each individual user on a website or mobile app. According to yet another embodiment, a data enrichment process may be implemented to introduce Meta tags that are associated with every element on screen. The data enrichment process converts meaningless X & Y coordinates from a clickstream into data models that correlate behavior with Intent i.e. through the data enrichment process, unstructured data is converted to a structured data. The data analytics platform categorizes the data and then processes using machine learning techniques which create data models that allow the authorized personals or administrators to observe and compare the structured data as shown in FIG. 3C. FIG. 3C thus illustrates an example of customer profiles generated or built based on enriched data models, according to an embodiment of the present invention. These profiles may be used to observe and compare the interests and information of each individual in order to assist in assessing their needs, their spending powers, their probable budget etc.

This allows the present method to track, learn and profile customers at scale and capture behavior at scale, track and store behavior and engagement in real-time across millions of visitors. According to exemplary embodiment, the disclosed method may represent customer profiles with models that indicate budget, Route, interests, experience, etc. Thus, the present method can profile the customers based on their preferences and can use the data to learn and profile your audience by interest through their past behavior. In a preferred embodiment, the additional process other than forming click graphs include data enrichment i.e. converting unstructured data into structured data, which allows machine learning algorithms to work on data models that can be acted upon using a plurality of rules such as business rules.

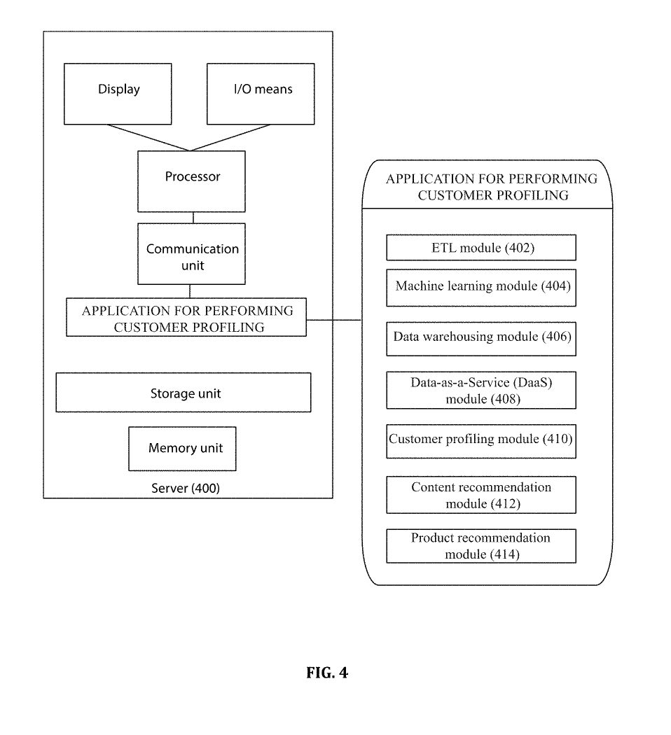

The collected information is transferred to the server (400) for further analysis and classification. FIG. 4 is a block diagram showing the different modules of the server (400) in communication with the electronic devices (102), according to a preferred embodiment of the present invention. The server (400) includes usual components present in a computer system such as the processor, storage module, memory module, I/O module, etc. Further the server (400) runs a data analysis and content predication software having a number of different modules such as an Extract, Transform and Load (ETL) module (402) to collect and process the information related to the interactions of the users from the electronic device (102), a machine learning module (404) for processing and categorizing the information and classifying the customers and performing profiling of the customers based on the information, a data warehousing module (406) to store and the information related to the interactions of each user and a data as a service (DaaS) module (408) in communication with the machine learning module (404) to provide product and content recommendations to the users.

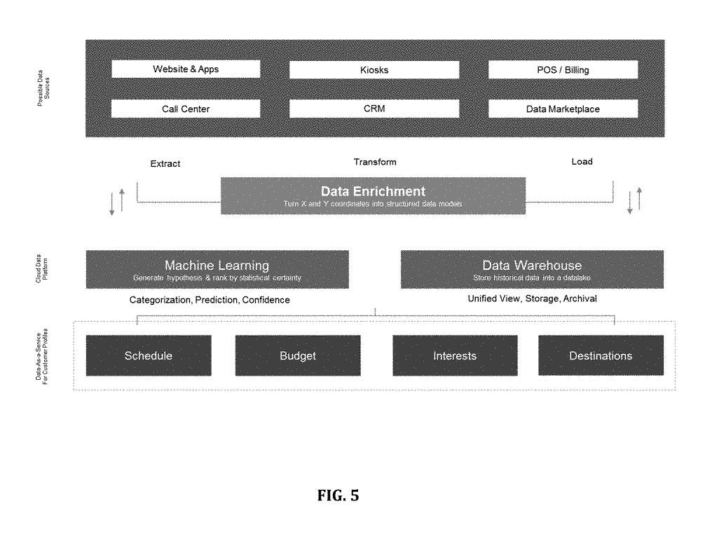

FIG. 5 is a block diagram showing the different processing blocks associated with the present system (100) and method for providing targeted contents to the customers in an online marketing environment, according to an embodiment of the present invention. The data analytics means such as the Google Analytics 360 tracks real-time behavior on web and mobile assets associated with the user. Then the ETL module (402) collect and process the information related to the interactions of the users from the electronic device (102). The collected information is processed in a cloud data platform, or the application running on the cloud server (400), which includes the modules such as the machine learning module (404) for processing and categorizing the information and classifying the customers and performing profiling of the customers based on the information, a data warehousing module (406) to store and the information related to the interactions of each user. In some instances, the machine learning module (404) make use of existing data analysis applications such as but not limited to Amazon Machine Learning/IBM Watson/Google Tensor Flow and the data warehousing module (406) employs popular services such as but not limited to Google Big query/Amazon Red Shift/IBM Cloudant, etc. Further the categorized data is sent to the DaaS module (408) in communication with the machine learning module (404) to provide product and content recommendations to the users. The DaaS module (408) includes several sub modules such as customer profiling module (410) for profiling the customers based on the plurality of information related to the interactions and interests of the customers and the historical behavior of the customers retrieved from the data warehousing module (406), content recommendation module (412) for recommending a plurality of services to the customers through a plurality of e-commerce platforms and a product recommendation module (414) for recommending a plurality of products to the customers through a plurality of e-commerce platforms based on the customer profile and the interactions and interests of the customers and the historical behavior of the customers. Then contents targeted to each customer preferences are presented to each customer through the user interface of the electronic device (102). Further the Data-as-a-Service (DaaS) module (408) enables a plurality of third party services to use the customer profiling data to provide personalized services and products to the customers. The DaaS module (408) processes the plurality of information from the machine learning module (404) and the data warehousing module (406) to provide personalized experiences to the customers in real-time through the plurality of e-commerce platforms.

The method for providing a plurality of targeted contents to a plurality of customers in an online marketing environment comprises the steps of collecting a plurality of information related to a plurality of interactions of the customers with a plurality of contents presented through a user interface of an electronic device (102), receiving and processing the plurality of information using an Extract, Transform and Load (ETL) module (402), categorizing the plurality of information using a machine learning module (404), storing the plurality of information using a data warehousing module (406) and processing the plurality of information using a Data-as-a-Service (DaaS) module (408) to provide to personalized recommendations to the customers in real-time. The data-as-a-Service (DaaS) module (408) performs the steps of profiling the customers using a customer profiling module (410) based on the plurality of information related to the interactions and interests of the customers and a plurality of historical behavior of the customers retrieved from the data warehousing module (406), recommending a plurality of services to the customers through a plurality of e-commerce platforms using a content recommendation module (412) and recommending a plurality of products to the customers through a plurality of e-commerce platforms using a content recommendation module (414). The machine learning module (404) captures a plurality of digital micro-conversions to track customer behavior and analyzes historical behavior of the customers to perform customer profiling and classification of the customers to predict customer demand and provide targeted products and services to the customers through the plurality of e-commerce platforms.

The present method employs data analytics tools such as the Google Analytics, and the collected information is processed to capture micro-conversions that are used to fuel machine learning processes by the machine-learning module (404) to profile and classify customers based on their interests. An example of micro conversion includes the case when someone browses for travel options near a beach, a river and a jungle through a web search engine or a website, the system (100) can profile the user as someone who is looking for outdoor experiences. Through machine learning and crunching through the user's preferences, the system (100) can identify the user's interests in eco-friendly activities and user's desire to assist in charitable activities. This data-points allow the system (100) to deliver additional intelligence to other platforms so that they in turn can respond in real-time and take action so that they are able to influence consideration through the use of Programmatic Buying Platforms or Web and Mobile Personalization Platforms in the online market. The present system generates a dashboard with data representing how Customer Profile data is ingested by decision support systems associated with the present system (100) for the present website or e-commerce platform or by the ones that they purchase from 3rd party vendors. The present Customer Profiling platform analyzes the purpose, budget and interests and the information are delivered via the Data-as-a-Service (DaaS) platform (408) so that it can be consumed by 3rd party solutions to make more effective decisions. In addition, the customer profiles can be fed into product or content recommendation engines (412) and (414) to take over so that they can deliver personalized narratives containing suitable content and products that facilitate conversion optimization and thereby obtaining improved customer purchase propensity, likelihood of acquiring add-ons, larger basket size, increased loyalty and publicity by word-of-mouth by the customers.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the appended claims.

Although the embodiments herein are described with various specific embodiments, it will be obvious for a person skilled in the art to practice the invention with modifications. However, all such modifications are deemed to be within the scope of the claims.

What is claimed is:

1. A computer implemented system for performing customer profiling of a plurality of customers for providing personalized contents to the customers in an online marketing environment comprising:
an electronic device capable of presenting a plurality of contents to a plurality of users through a user interface,
wherein the electronic device comprises:
at least one processor to process a plurality of instructions to collect a plurality of information related to a plurality of interactions of the user on the contents presented through the user interface; and
at least one communication module to transfer the plurality of information related to the plurality of interactions of the users over a communication channel;
a central server in communication with the electronic device to receive the plurality of information related to the interactions of the users on the contents presented to the users through the user interface of the electronic device,
wherein the central server receives the plurality of information related to the interactions of the users through the communication channel;
at least one application running on the central server analyzes the information related to the interactions of the users, wherein the application includes:
an Extract, Transform and Load (ETL) module to collect and process the information related to the interactions of the users from the electronic device;
a machine learning module for processing and categorizing the information and classifying the customers and performing profiling of the customers based on the information;
a data warehousing module to store and the information related to the interactions of each user; and
a data as a service (DaaS) module in communication with the machine learning module to provide product and content recommendations to the users;
characterized in that the application captures a plurality of digital micro-conversions to track customer behavior and analyzes historical behavior of the customers to perform customer profiling and classification of the customers to predict demand and provide targeted products and services to the customers through a plurality of e-commerce platforms.

2. The system of claim 1, wherein the ETL module receives the plurality of information related to the customer interactions with the contents using a data analytics platform, wherein the data analytics platform includes Google analytics and Google 360 platforms.

3. The system of claim 2, wherein the data analytics platforms are modified to include a plurality of instructions to generate scroll map and click map of customer interactions to gather information related to the customer behavior on the contents presented to the customers.

4. The system of claim 1, wherein the ETL module processes the information received from a plurality of data analytics platforms to generate a plurality of structured data related to each customer profile.

5. The system of claim 1, wherein the machine learning module processes a plurality of structured data received from the ETL module to calculate the digital micro-conversions associated with each customer profile to track behavior of each customer.

6. The system of claim 1, wherein the machine learning module profile customers based on a plurality of real-time and past interests of the customers and categorizes and ranks the interests by statistical certainty.

7. The system of claim 1, wherein the data as a service (DaaS) module exposes a plurality of customer profile information in form of exposed web services to a plurality third party services to offer targeted products and services to customers.

8. A method for providing a plurality of targeted contents to a plurality of customers in an online marketing environment comprising:
collecting a plurality of information related to a plurality of interactions of the customers with a plurality of contents presented through a user interface of an electronic device;
receiving and processing the plurality of information using an Extract, Transform and Load (ETL) module;
categorizing the plurality of information using a machine learning module;
storing the plurality of information using a data warehousing module;
processing the plurality of information using a Data-as-a-Service (DaaS) module to provide to personalized recommendations to the customers in real-time, wherein the Data-as-a-Service (DaaS) module performs the steps of:
profiling the customers using a customer profiling module based on the plurality of information related to the interactions and interests of the customers and a plurality of historical behavior of the customers retrieved from the data warehousing module;
recommending a plurality of services to the customers through a plurality of e-commerce platforms using a content recommendation module; and
recommending a plurality of products to the customers through a plurality of e-commerce platforms using a product recommendation module;
characterized in that the machine learning module captures a plurality of digital micro-conversions to track customer behavior and analyzes historical behavior of the customers to perform customer profiling and classification of the customers to predict customer demand and provide targeted products and services to the customers through the plurality of e-commerce platforms.

9. The method of claim 1, wherein the Data-as-a-Service (DaaS) module enable a plurality of third party services to use the customer profiling data to provide personalized services and products to the customers.

10. The method of claim 3, wherein the DaaS module processes the plurality of information from the machine learning module and the data warehousing module to provide personalized experiences to the customers in real-time through the plurality of e-commerce platforms.
